(19) United States
(12) Patent Application Publication
(10) Pub. No.: US 2026/0211545 A1
(43) Pub. Date: Jul. 23, 2026

(54) ELECTRONIC DEVICE, METHOD, AND NON-TRANSITORY COMPUTER-READABLE RECORDING MEDIUM FOR DISPLAYING WIDGET

(71) Applicant: SAMSUNG ELECTRONICS CO., LTD., Suwon-si (KR)

(72) Inventors: Yoechan SONG, Suwon-si (KR); Dukhyun Kim, Suwon-si (KR); Sangheon Kim, Suwon-si (KR); Junsung Kim, Suwon-si (KR); Dongil Son, Suwon-si (KR); Yeunwook Lim, Suwon-si (KR)

(73) Assignee: SAMSUNG ELECTRONICS CO., LTD., Suwon-si (KR)

(21) Appl. No.: 19/576,911

(22) Filed: Mar. 24, 2026

Related U.S. Application Data
(63) Continuation of application No. PCT/KR2024/012459, filed on Aug. 21, 2024.

(30) Foreign Application Priority Data
Oct. 13, 2023 (KR) 10-2023-013214
Nov. 15, 2023 (KR) 10-2023-0158505

(51) Int. Cl. G06F 3/04845; G06T 11/60

(52) U.S. Cl. CPC G06F 3/04845; G06T 11/60; G06T 2200/24; G06T 2210/22

(57) ABSTRACT

A method executed by an electronic device including a display, includes: identifying an input to a change in a size of a widget displayed on a screen of the display; changing the size of the widget based on the input; identifying a widget template object corresponding to the changed size of the widget and first attributes of one or more first objects included in the widget; relocating, based on the widget template object, the one or more first objects to a resized widget having the changed size; and displaying the resized widget including the one or more first relocated objects on the screen.

### CROSS-REFERENCE TO RELATED APPLICATIONS

This application is a by-pass continuation application of International Application No. PCT/KR2024/012459, filed on Aug. 21, 2024, which is based on and claims priority to Korean Patent Application No. 10-2023-0137214, filed on Oct. 13, 2023, and Korean Patent Application No. 10-2023-0158505, filed on Nov. 15, 2023, in the Korean Ministry of Intellectual Property, the disclosures of which are incorporated by reference herein their entireties.

### BACKGROUND

### 1. Field

The disclosure relates to an electronic device, a method, and a non-transitory computer readable storage medium displaying a widget.

### 2. Description of Related Art

A widget is a graphic user interface (GUI) for controlling some functions of an application in association with the widget and/or displaying information. For example, the widget may be an information widget or a management widget. For example, the widget may be an integrated widget in which the information widget and the management widget are mixed. For example, the widget may be referred to as a mini-application for an application in association with the widget.

A size of the widget may be changed on a screen displayed on a display. As the size of the widget is changed, a size of one or more objects included in the widget may be changed.

### SUMMARY

According to an aspect of the disclosure, an electronic device includes: a display, at least one processor, and memory storing instructions, wherein the instructions, when executed by the at least one processor, to cause the electronic device to: identify an input to a change in a size of a widget displayed on a screen of the display, change the size of the widget based on the input, identify a widget template object corresponding to the changed size of the widget and identify first attributes of one or more first objects included in the widget, relocate, based on the widget template object, the one or more first objects to a resized widget having the changed size, and display the resized widget including the one or more first relocated objects on the screen.

According to an aspect of the disclosure, a method executed by an electronic device including a display, includes: identifying an input to a change in a size of a widget displayed on a screen of the display; based on the input, changing the size of the widget based on the input; identifying a widget template object corresponding to the changed size of the widget and first attributes of one or more first objects included in the widget; relocating, based on the widget template object, the one or more first objects to a resized widget having the changed size; and displaying the resized widget including the one or more first relocated objects on the screen.

According to an aspect of the disclosure, a non-transitory computer readable storage medium, storing a program including instructions, wherein the instructions, when executed by at least one processor of an electronic device including a display, cause the electronic device to: identify an input to a change in a size of a widget displayed on a screen of the display, change the size of the widget based on the input, identify a widget template object corresponding to the changed size of the widget and first attributes of one or more first objects included in the widget, relocate, based on the widget template object, the one or more first objects to a resized widget having the changed size, and display the resized widget including the one or more first relocated objects on the screen.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to various embodiments;

FIG. 2A is a block diagram of an electronic device according to an embodiment

FIG. 2B illustrates an example of a widget according to an embodiment;

FIG. 2C illustrates an example of an input to a widget according to an embodiment;

FIG. 2D illustrates an example of an input to a widget according to an embodiment;

FIG. 3A is a block diagram of a widget analyzer according to an embodiment;

FIG. 3B is a block diagram of an object extractor according to an embodiment;

FIG. 4A is a block diagram of a widget corrector according to an embodiment;

FIG. 4B is a block diagram of an image processor according to an embodiment;

FIG. 4C is a block diagram of a model selector according to an embodiment;

FIG. 5 illustrates an example of screens according to an embodiment;

FIG. 6 illustrates an example of a screen according to an embodiment;

FIG. 7 illustrates an example of screens according to an embodiment;

FIG. 8 is a flowchart indicating an operation of an electronic device according to an embodiment;

FIG. 9 is a flowchart indicating an operation of an electronic device according to an embodiment;

FIG. 10 is a flowchart indicating an operation of an electronic device according to an embodiment;

FIG. 11 is a flowchart indicating an operation of an electronic device according to an embodiment; and

FIG. 12 is a diagram illustrating examples of widget template objects, according to an embodiment.

### DETAILED DESCRIPTION

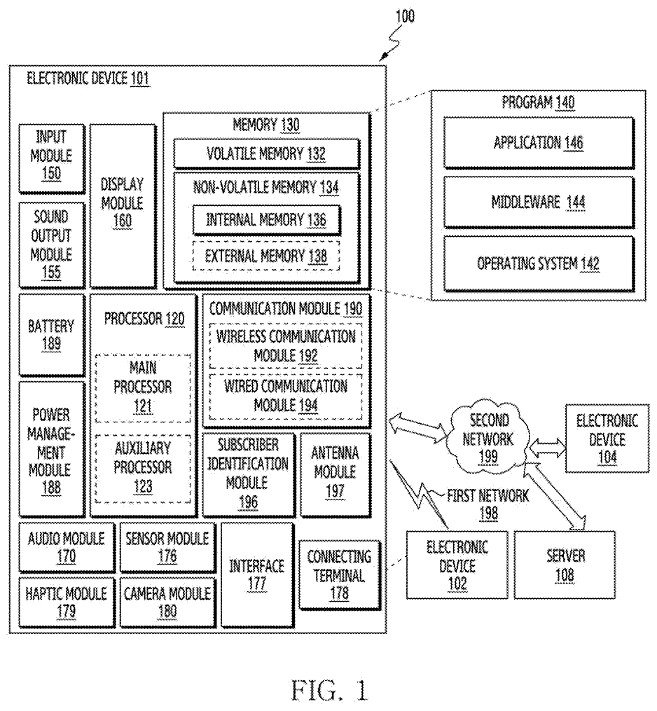

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include at least one processor 120, memory 130, an input module 150, a sound output module 155, a display module (or display) 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning operations may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., through a wire or wires) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., through a wire or wires) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to (or based on) a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

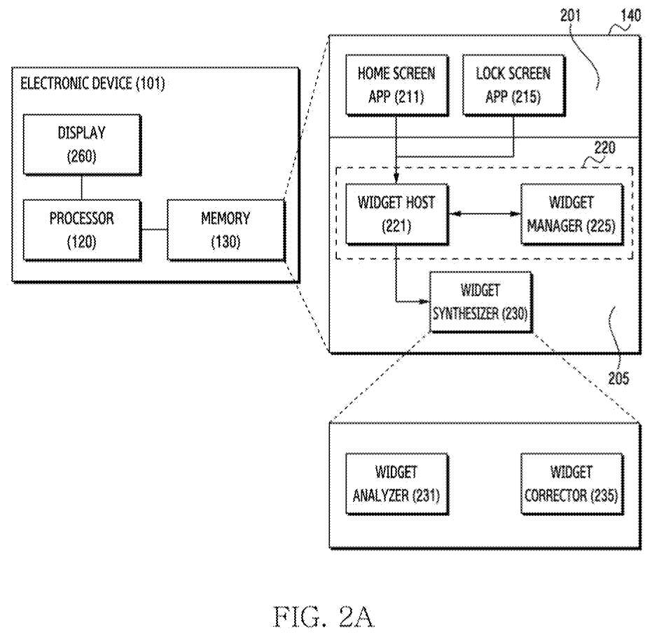

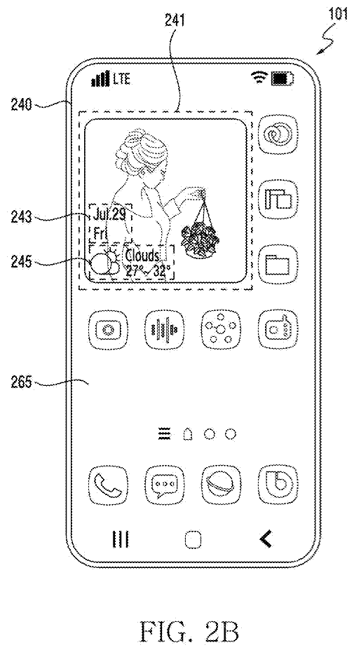

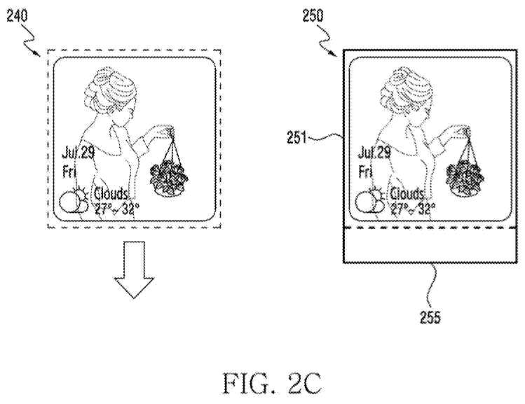

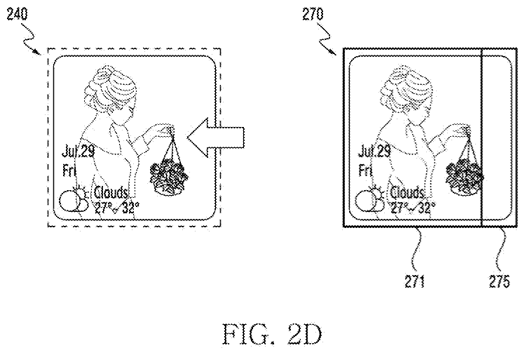

FIG. 2A is a block diagram of an electronic device 101 according to an embodiment. FIG. 2B illustrates an example of a widget 240 according to an embodiment. FIG. 2C illustrates an example of an input to a widget 240 according to an embodiment. FIG. 2D illustrates an example of an input to a widget 240 according to an embodiment;

The electronic device 101 of FIG. 2A may be an example of the electronic device 101 of FIG. 1.

Referring to FIG. 2A, the electronic device 101 may include at least one processor 120, memory 130, and a display 260. In an embodiment, the memory 130 may store a program 140. The processor 120 of FIG. 2A may be an example of the processor 120 of FIG. 1. The memory 130 of FIG. 2A may be an example of the memory 130 of FIG. 1. The program 140 of FIG. 2A may be an example of the program 140 of FIG. 1. The display 260 of FIG. 2A may be an example of the display module 160 of FIG. 1.

In an embodiment, the program 140 of the memory 130 may be included in an application layer 201 or a framework layer 205. In an embodiment, the application layer 201 and/or the framework layer 205 may include one or more applications (hereinafter, an APP). For example, the application layer 201 may include a home screen APP 211 and/or a lock screen APP 215. In an embodiment, the framework layer 205 may include a widget framework 220 and/or a widget synthesizer 230.

In an embodiment, the program 140 of the memory 130 may include one or more program modules. In an embodiment, the widget framework 220 may include a widget host 221 and/or a widget manager 225. The widget manager 225 may update a state of the widget 240. In an embodiment, the widget synthesizer 230 may include a widget analyzer 231 and/or a widget corrector 235.

In an embodiment, the home screen APP 211 may generate a screen including one or more icons and/or one or more widgets. In an embodiment, the home screen APP 211 may display the generated screen on the display 260. In an embodiment, a widget may be a graphic user interface (GUI) for controlling some functions of an application in association with the widget and/or displaying information. In an embodiment, the widget may be divided into an information widget, a management widget, or a hybrid widget for information and management. In an embodiment, the information widget may display an information element (e.g., current weather or currently playing song information) provided by an application in association with the widget. In an embodiment, the management widget may display a function element (e.g., next song playback or pause) provided by an application in association with the widget. For example, the electronic device 101 may control some functions of an application in association with the widget in response to (or based on) a selection of the function element provided by the management widget. In an embodiment, the hybrid widget may display the information element and the function element provided by an application in association with the widget. For example, a widget may be referred to as a mini-application for an application in association with the widget.

Referring to FIG. 2B, in an embodiment, a screen 265 generated by the home screen APP 211 may include the widget 240. In an embodiment, the widget 240 may include a widget host view (or a frame). The widget host view of the widget 240 may include a background image 241. The widget 240 may include a widget view. The widget view of the widget 240 may include information elements 243 and 245. However, embodiments of the present disclosure are not limited thereto. The widget view of the widget 240 may include the information elements 243 and 245 and/or management elements. Hereinafter, the background image 241, the information elements 243 and 245, and/or the management elements included in the widget 240 may be referred to as an object. In addition, one or more elements (e.g., a person, a flower basket, a hand, an animal, and an item) of the background image 241 included in the widget 240 may also be referred to as an object.

In an embodiment, the lock screen APP 215 may display a lock screen on the display 260 to prevent an unauthorized access (or input). In an embodiment, the lock screen generated by the lock screen APP 215 may include one or more icons and/or one or more widgets.

Referring back to FIG. 2A, the widget host 221 of the widget framework 220 may be a program for interaction with the widget 240 displayed on a screen of the home screen APP 211 and/or the lock screen APP 215. The APP of the application layer 201 may interact with the widget host 221.

In an embodiment, the widget host 221 may transmit an input (e.g., a touch input through the display 260) to the widget 240 to an APP for the widget 240. For example, the widget host 221 may transmit an input on the screen of the home screen APP 211 and/or the lock screen APP 215 to the APP for the widget 240. In an embodiment, based on the input transmitted from the widget host 221, the APP for the widget 240 may perform a function and transmit a result of performing the function to the widget host 221.

In an embodiment, the widget host 221 may transmit an input (e.g., a touch input through the display 260) to the widget 240 to the widget synthesizer 230. For example, the widget host 221 may transmit an input on the screen of the home screen APP 211 and/or the lock screen APP 215 to the widget synthesizer 230.

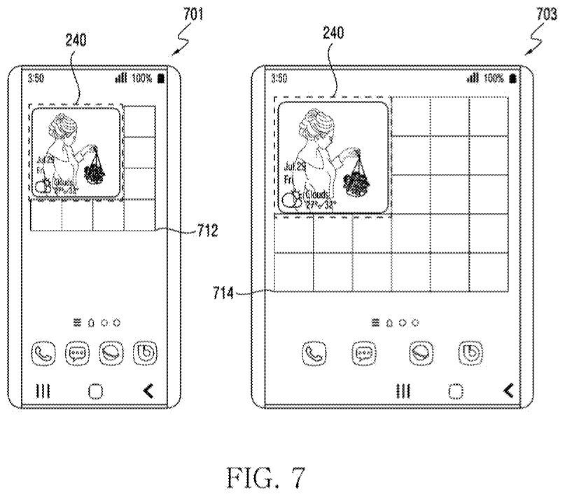

In an embodiment, when an input that causes a change in a state associated with display of the widget 240 is identified, the widget host 221 may transmit, to the widget synthesizer 230, an input to the widget 240. The input that causes a change in the state associated with the display of the widget 240 may include an input that causes a change in a size and/or a ratio of the widget 240. For example, the input that causes a change in the state associated with the display of the widget 240 may include an input for changing a lattice structure (e.g., a lattice structure 712 or 714 of FIG. 7) of a screen 265 of the display 260. For example, the input that causes a change in the state associated with the display of the widget 240 may include an input to the widget 240 for causing a change in the size of the widget 240. For example, the input that causes a change in the state associated with the display of the widget 240 may include an input to another widget other than the widget 240 that causes a change in the size of the widget 240. For example, as the input to the other widget is moved in a direction of the widget 240, the size of the widget 240 may be changed.

Referring to FIG. 2C, the widget host 221 may identify an input 249 for changing the widget 240 to a widget 250 enlarged in a downward direction. In an embodiment, by the input 249, the widget 240 may be changed to the widget 250 that further includes an additional region 255 in addition to an existing region 251. Referring to FIG. 2D, the widget host 221 may identify an input 280 for changing to a widget 270 that is reduced from a right direction of the widget 240. In an embodiment, by the input 280, the widget 240 may be changed to the widget 250 from which an exclusion region 275 is excluded from existing regions 271 and 275. In an embodiment, the widget host 221 may identify the input 249 or 280 as the input that causes (or that corresponds to) a change in the state associated with the display of the widget 240.

Referring back to FIG. 2A, the widget synthesizer 230 may include the widget analyzer 231 and/or the widget corrector 235.

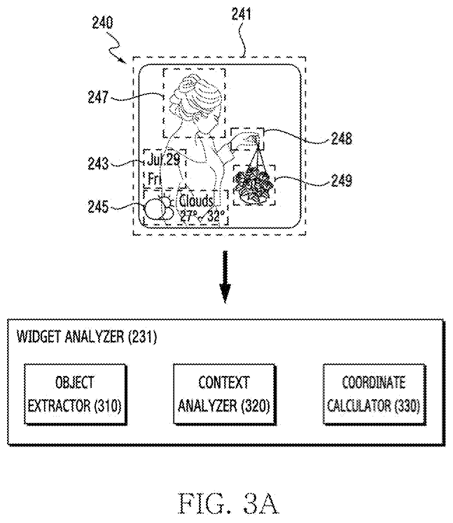

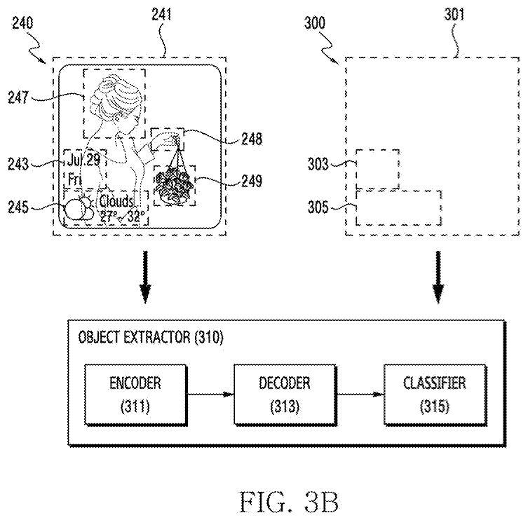

In an embodiment, the widget synthesizer 230 may analyze the widget 240 based on an input transmitted from the widget host 221. The widget synthesizer 230 may analyze the widget 240 through the widget analyzer 231 based on the input transmitted from the widget host 221. An operation of analyzing the widget 240 by the electronic device 101 may be described with reference to FIGS. 3A and 3B. In an embodiment, the input transmitted from the widget host 221 may include information on an input event and/or information on the widget 240 to which the input is inputted. For example, the information on the input event may indicate whether a size and/or a grid of the widget 240 have been changed.

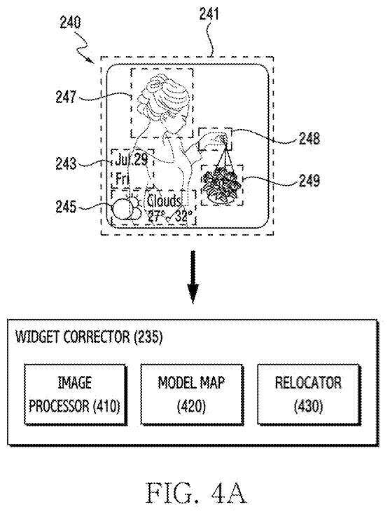

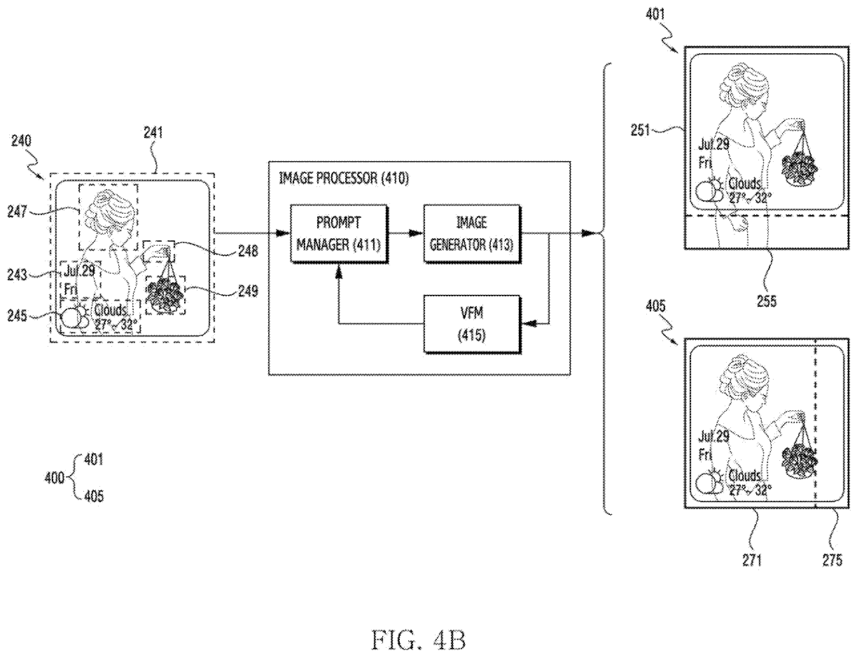

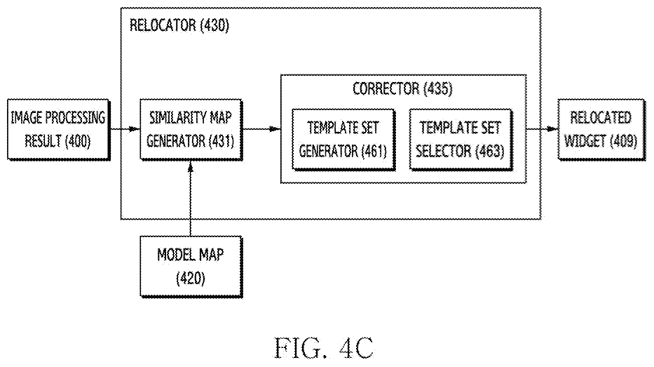

In an embodiment, the widget synthesizer 230 may adjust the widget host view and/or the widget view of the widget 240 based on the input transmitted from the widget host 221. In an embodiment, the widget synthesizer 230 may adjust the widget host view and/or the widget view of the widget 240 through the widget corrector 235 based on the input transmitted from the widget host 221. In an embodiment, the widget synthesizer 230 may transmit a result of performing a performed function to the widget host 221 based on the input transmitted from the widget host 221. An operation of analyzing the widget 240 by the electronic device 101 may be described with reference to FIGS. 4A, 4B, and 4C.

In an embodiment, the widget host 221 may generate (or draw) the widget 250 or 270 in which a size and/or a ratio have been adjusted based on a result of adjusting the widget 240 from the widget synthesizer 230. In an embodiment, the widget host 221 may display the generated widget 250 or 270 on a screen (e.g., the screen of the home screen APP 211 and/or the lock screen APP 215).

FIG. 3A is a block diagram of a widget analyzer 231 according to an embodiment. FIG. 3B is a block diagram of an object extractor 310 according to an embodiment.

The widget analyzer 231 of FIG. 3A may be an example of the widget analyzer 231 of FIG. 2A. The object extractor 310 of FIG. 3B may be included in the widget analyzer 231 of FIGS. 2A and/or 3A.

Referring to FIG. 3A, the widget analyzer 231 may include an object extractor 310, a context analyzer 320, and/or a coordinate calculator 330.

In an embodiment, the widget analyzer 231 may analyze objects 241, 243, and 245 in a widget 240. In an embodiment, the widget analyzer 231 may extract (or identify) the objects 241, 243, and 245 from the widget 240. In an embodiment, the widget analyzer 231 may analyze (or identify) context of each of the objects 241, 243, and 245 of the widget 240. In an embodiment, the widget analyzer 231 may calculate (or identify) size information and/or position information of each of the objects 241, 243, and 245 of the widget 240. In an embodiment, context of an object may indicate an attribute (e.g., a background image, an information element, or the information element) of the object. In an embodiment, context of an object may indicate an attribute (e.g., a text size, a text type, an icon, or an image) of one or more elements included in the object. In an embodiment, context of an object may indicate a type (e.g., a calendar, a person, a face 247, a hand 248, a flower basket 249, weather information, an item, or an animal) of one or more elements included in the object.

In an embodiment, the object extractor 310 may extract (or identify) the objects 241, 243, 245, 247, 248, and 249 from the widget 240. In an embodiment, the object extractor 310 may extract (or identify) the objects 241, 243, and 245 from the widget 240 based on an image analysis operation or algorithm (e.g., a diffusion model or a convolution neural network (CNN)). In an embodiment, the object extractor 310 may classify (or identify) a class for each of the objects 241, 243, 245, 247, 248, and 249 extracted from the widget 240. In an embodiment, the class may indicate a type (e.g., the calendar, the person, the face 247, the hand 248, the flower basket 249, the weather information, the item, or the animal).

Referring to FIG. 3B, the object extractor 310 may include an encoder 311, a decoder 313, and a classifier 315.

In an embodiment, the encoder 311 may be configured to extract a feature map. Herein, the feature map may indicate one or more ‘regions of interest’ (ROIs) of the widget 240. For example, the feature map for the widget 240 may have the person 247, the flower basket 249, a flower in the flower basket, the hand 248 of the person, the text 243 or 245, and/or an icon as the ROI.

In an embodiment, the encoder 311 may transmit the feature map for each of the ROIs of the widget 240 to the decoder 313.

In an embodiment, the decoder 313 may select some ROIs from among the ROIs. In an embodiment, the decoder 313 may select some ROIs for the designated objects 241, 243, and 245 of the widget 240 from among the ROIs. To this end, the decoder 313 may be trained to select an ROI for the designated objects 241, 243, and 245 in an original image through data 300 having ROIs 301, 303, and 305. For example, the decoder 313 may be trained in a supervised manner to select some ROIs surrounding the designated objects 241, 243, and 245 in the original image from other data in which any ROI (or an ROI according to Gaussian noise) is added to the data 300 having the designated ROIs 301, 303, and 305.

In an embodiment, the classifier 315 may classify a type of the objects 241, 243, and 245 surrounded by some selected ROIs. In an embodiment, the classifier 315 may classify whether the objects 241, 243, and 245 are an information element, a management element, a background image, or one or more elements included in the background image.

Referring back to FIG. 3A, the context analyzer 320 may analyze (or identify) the context of each of the objects 241, 243, and 245 of the widget 240.

In an embodiment, the context analyzer 320 may analyze (or identify) the context for the objects 241, 243, and 245 of the widget 240 extracted from the object extractor 310. In an embodiment, the context analyzer 320 may analyze (or identify) the context for the objects 241, 243, and 245 of the widget 240 extracted from the object extractor 310 based on a context extraction operation or algorithm (e.g., a captioning model). In an embodiment, the context analyzer 320 may extract one or more prompts describing the objects 241, 243, and 245 based on the context extraction operation or algorithm (e.g., the captioning model). Herein, the prompt may be a set of words. The prompt may be a set of words (and/or keywords) that may be extracted from the objects 241, 243, and 245. For example, the word (and/or the keyword) may be a word describing a state or a property of the objects 241, 243, and 245. For example, the word (and/or the keyword) may be a word describing a position, a relationship, movement, or an action of the at least one object 241, 243, and/or 245.

In an embodiment, the context analyzer 320 may analyze (or identify) the context based on a type of each of the objects 241, 243, and 245. For example, the context analyzer 320 may generate context for the object 241 based on information that the object 241 is a background image, includes a woman including the face 247 and the hand 248, and includes the flower basket 249. For example, the context for the object 241 may be “a girl holding a flower basket with her left hand, wearing a white cloth, and slightly lowering her head”. For example, the context analyzer 320 may generate context for the object 243 based on information that the object 243 is an information element and includes date information in English. For example, the context for the object 243 may be “a calendar including an abbreviated English month, a number, and an abbreviated English day of the week below”. For example, the context analyzer 320 may generate context for the object 245 based on information that the object 245 is an information element and includes weather information in English. For example, the context for the object 245 may be “weather information representing a high temperature and a temperature, including a cloud-shaped icon”.

In an embodiment, the coordinate calculator 330 may calculate, or identify) size information and/or position information of each of the objects 241, 243, and 245. For example, the position information may indicate a distance from a designated side (e.g., an upper side or a left side) of a frame of the widget 240 of each of the objects 241, 243, and 245. For example, the size information may indicate a vertical length and/or a horizontal length of each of the objects 241, 243, and 245. However, embodiments of the present disclosure are not limited thereto.

In an embodiment, the widget analyzer 231 may transmit the context for the objects 241, 243, and 245 of the widget 240 extracted from the object extractor 310 to the widget corrector 235 and/or the widget host 221. In an embodiment, the widget analyzer 231 may transmit an attribute of an object for the objects 241, 243, and 245 of the widget 240 extracted from the object extractor 310, an attribute of one or more elements included in the object, a type of the elements, a prompt of the object, size information of the object, and/or position information to the widget corrector 235 and/or the widget host 221.

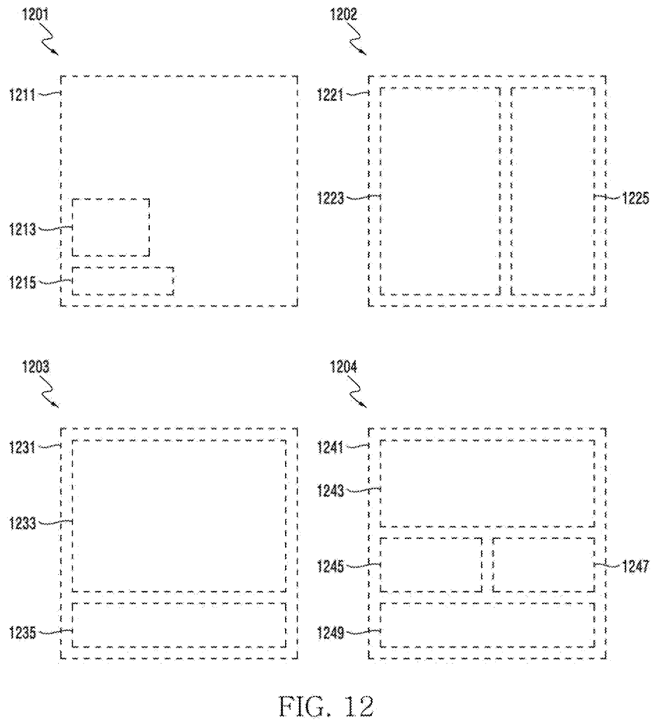

FIG. 4A is a block diagram of a widget corrector 235 according to an embodiment. FIG. 4B is a block diagram of an image processor 410 according to an embodiment. FIG. 4C is a block diagram of a relocator 430 according to an embodiment. FIG. 12 is a diagram illustrating examples of widget template objects, according to an embodiment.

The widget corrector 235 of FIG. 4A may be an example of the widget corrector 235 of FIG. 2A. The image processor 410 of FIG. 4B may be included in an image processor 410 of FIGS. 2A and/or 4A. The relocator 430 of FIG. 4C may be included in a relocator 430 of FIGS. 2A and/or 4A.

Referring to FIG. 4A, the widget corrector 235 may include the image processor 410, a model map 420, and/or the relocator 430.

In an embodiment, the widget corrector 235 may perform image processing for objects 241, 243, and 245 in a widget 240. In an embodiment, the widget corrector 235 may perform image processing for the objects 241, 243, and 245 in the widget 240 in response to (or based on) a request from a widget analyzer 231 and/or a widget host 221. In an embodiment, the widget analyzer 231 may identify a widget template object 1201 for locating the objects 241, 243, and 245 among a plurality of widget template objects 1201, 1202, 1203, 1204. For example, FIG. 12 may visually illustrate widget template objects 1201, 1202, 1203, and 1204. For example, a widget template object 1201 may be data having location information, attribute information, and/or a prompt of one or more objects 1211, 1213, and 1215 on a widget. For example, attribute information of the widget template object 1201 may indicate an attribute (e.g., a type (e.g., an image, a text, or an icon), a function (e.g., information delivery or control), or a size) of one or more objects 1211, 1213, and 1215 included in the widget template object 1201. In an embodiment, the prompt may be a word describing a state or a property of one or more objects 1211, 1213, and 1215 included in the widget template object 1201. For example, a widget template object 1202 may be data having location information, attribute information, and/or a prompt of one or more objects 1221, 1223, and 1225 on a widget. For example, a widget template object 1203 may be data having location information, attribute information, and/or a prompt of one or more objects 1231, 1233, and 1235 on a widget. For example, a widget template object 1204 may be data having location information, attribute information, and/or a prompt of one or more objects 1241, 1243, 1245, 1247, and 1249 on a widget.

For example, a plurality of widget template objects 1201, 1202, 1203, and 1204 may define data of an attribute, a state, or a property that may be merged with (or addable to) the objects 1211, 1213, 1215, 1221, 1223, 1225, 1231, 1233, 1235, 1241, 1243, 1245, 1247, and 1249. For example, the plurality of widget template objects 1201, 1202, 1203, and 1204 may define sizes and/or locations of the objects 1211, 1213, 1215, 1221, 1223, 1225, 1231, 1233, 1235, 1241, 1243, 1245, 1247, and 1249.

In an embodiment, the widget corrector 235 may relocate the objects 241, 243, and 245 based on the selected widget template object 1201. In an embodiment, the widget corrector 235 may relocate the objects 243 and 245 on the object 241, which is a background image of the image-processed widget 240, based on the selected widget template object 1201. Herein, the image processing may include enlargement, reduction, cropping, and/or out-painting of an image. Herein, the out-painting may be an operation for drawing a new image in association with an image in an outer region of the image.

In an embodiment, the image processor 410 may perform image processing for the objects 241, 243, and 245 in the widget 240. In an embodiment, the image processor 410 may change a size of a frame of each of the objects 241, 243, and 245 in the widget 240. In an embodiment, the image processor 410 may perform image processing for an image object among the objects 241, 243, and 245 in the widget 240. In an embodiment, the image processor 410 may perform image processing for the objects 241, 243, and 245 such that the image object is drawn in the changed frame. In an embodiment, the image processor 410 may perform image processing for the image object based on context of the image object of the widget 240. In an embodiment, the image processor 410 may perform at least one of enlargement, reduction, cropping, or out-painting on the image object. In an embodiment, the image processor 410 may perform at least one of enlargement, reduction, cropping, or out-painting on the image object based on the context of the image object of the widget 240.

In an embodiment, the image processor 410 may select a region to be preserved and/or a region to be excluded from the image object through cropping. In an embodiment, the image processor 410 may select the region to be preserved and/or the region to be excluded from the image object based on one or more elements (e.g., a face 247, a hand 248, and a flower basket 249) included in the image object.

Referring to FIG. 4B, the image processor 410 may include a prompt manager 411, a generative artificial intelligence (AI) model 413, and visual foundation models (VFMs) 415. In an embodiment, the generative AI model 413 may include an AI model including a plurality of parameters associated with a neural network having a structure based on an encoder and a decoder, such as a transformer.

In an embodiment, the prompt manager 411 may obtain context for the objects 241, 243, and 245 of the widget 240. In an embodiment, the prompt manager 411 may obtain the context for the objects 241, 243, and 245 of the widget 240 from a context analyzer 320. However, embodiments of the present disclosure are not limited thereto. In an embodiment, the prompt manager 411 may analyze (or identify) the context for the objects 241, 243, 245 of the widget 240 extracted from an object extractor 310 based on a context extraction operation or algorithm (e.g., a captioning model). Herein, the context for the objects 241, 243, and 245 may include a prompt, which is a set of words. The prompt may be a set of words (and/or keywords) that may be extracted from the objects 241, 243, and 245. For example, the word (and/or the keyword) may be a word describing a state or a property of the objects 241, 243, and 245. For example, the word (and/or the keyword) may be a word describing a position, a relationship, movement, or an action of the at least one object 241, 243, and/or 245.

In an embodiment, the prompt manager 411 may determine (or identify) at least one of enlargement, reduction, cropping, or out-painting to be performed on the image object, based on the context of the image object of the widget 240. In an embodiment, the prompt manager 411 may determine (or identify) at least one of enlargement or out-painting to be performed on the image object, in response to the widget 240 being enlarged by an input. In an embodiment, the prompt manager 411 may determine (or identify) at least one of reduction or cropping to be performed on the image object, in response to the widget 240 being reduced by an input.

In an embodiment, in a case that the image object includes an element that does not require a change in a ratio, the prompt manager 411 may determine (or identify) at least one of cropping or out-painting, other than enlargement or reduction. In an embodiment, in a case that a change in a ratio of all elements included in the image object is allowed, the prompt manager 411 may determine (or identify) at least one of enlargement or reduction, other than cropping or out-painting. However, embodiments of the present disclosure are not limited thereto.

In an embodiment, the prompt manager 411 may transmit an image object included in the widget 240 and a prompt for the image object to the generative AI model 413. In an embodiment, the prompt manager 411 may request at least one of enlargement, reduction, cropping, or out-painting for the image object to the generative AI model 413. In an embodiment, the prompt manager 411 may request the generative AI model 413 to perform at least one of enlargement, reduction, cropping, or out-painting of the image object while maintaining the elements 247, 248, and 249 included in the object 241.

In an embodiment, the prompt manager 411 may determine (or identify) whether a generated image object obtained from the prompt manager 411 matches a requested result. In an embodiment, the prompt manager 411 may request the generative AI model 413 to output the generated image object, in a case that at least one of enlargement, reduction, cropping, or out-painting of the image object is performed while a generated image object obtained from the generative AI model 413 maintains the elements 247, 248, and 249.

In an embodiment, the generative AI model 413 may identify whether image processing for the image object is required based on the request from the prompt manager 411. In an embodiment, when it is identified that image processing for the image object is required, the generative AI model 413 may request image processing to the VFM 415. In an embodiment, when it is identified that image processing for the image object is not required, the generative AI model 413 may output an image generated by the VFM 415.

In an embodiment, the VFM 415 may perform at least one of enlargement, reduction, cropping, or out-painting of an image object based on a prompt. In an embodiment, the VFM 415 may generate an image object in which at least one of enlargement, reduction, cropping, or out-painting is performed, based on the prompt.

Referring to FIG. 4B, an image object 401 generated from the object 241 may be generated by out-painting a new image from an existing region 251 to an additional region 255. Referring to FIG. 4B, an image object 405 generated from the object 241 may be generated by cropping a cropping region 271 excluding an exclusion region 255 from existing regions 271 and 275.

In an embodiment, the VFM 415 may transmit the generated image object to the prompt manager 411. In an embodiment, in a case that the generated image object obtained from the prompt manager 411 matches the requested result, the prompt manager 411 may request the generative AI model 413 to output the generated image object. In an embodiment, the generative AI model 413 may output the image object generated by the VFM 415 in response to the output request of the image object. Herein, the image object outputted from the image processor 410 may be referred to as an image processing result 400. The image processing result 400 may be the image object 401 or the image object 405.

Referring back to FIG. 4A, the relocator 430 may identify a widget template object for locating the objects 241, 243, and 245 among a plurality of widget template objects included in the model map 420. Herein, the widget template object may be data having location information, attribute information, and/or a prompt of one or more objects on a widget. In an embodiment, the attribute information may indicate an attribute (e.g., a type (e.g., an image, a text, or an icon), a function (e.g., information delivery or control), or a size) of one or more objects included in a widget template object. In an embodiment, the prompt may be a word describing a state or a property of one or more objects included in a widget template object.

In an embodiment, the relocator 430 may include an AI model including a plurality of parameters associated with a neural network having a structure based on an encoder and a decoder, such as a transformer. In an embodiment, the AI model may include a bi-directional model (e.g., a bidirectional encoder representations from transformers (BERT)) or an auto-encoding model (e.g., a diffusion model) based on training for the encoder. In an embodiment, the AI model may include an autoregressive model (e.g., a generative pre-trained transformer (GPT)) based on training for the decoder. In an embodiment, the AI model may include a sequence-to-sequence model (e.g., a stable diffusion or DALL-E 2) based on training for the encoder and the decoder. In an embodiment, the AI model may include a large language model (LLM) for processing natural language based on massive parameters. However, embodiments of the present disclosure are not limited thereto. The AI model may include parameters for driving a neural network such as a convolutional neural network (CNN), a recurrent neural network (RNN), a feedforward neural network (FNN), and/or a long short-term memory (LSTM).

In an embodiment, the relocator 430 may identify the widget template object by inputting a changed size of the widget 240 and attributes (e.g., a type (e.g., an image, a text, or an icon), a function (e.g., information delivery or control), and a size) of the one or more first objects 241, 243, 245, 247, 248, and 249 into the AI model. The AI model may be trained to output the widget template object indicating location information of the one or more objects 241, 243, 245, 247, 248, and 249 based on the changed size and the attributes of the one or more objects 241, 243, 245, 247, 248, and 249. The AI model may be trained to output at least one widget template object based on an input (e.g., the changed size and the attributes of the one or more objects 241, 243, 245, 247, 248, and 249) based on the plurality of widget template objects included in the model map 420.

Referring to FIG. 4C, the relocator 430 may include a similarity map generator 431, and/or a corrector 435. In an embodiment, the corrector 435 may include a template set selector 461 and a widget generator 463.

In an embodiment, the similarity map generator 431 may generate a similarity map indicating similarity between the widget 240 and the plurality of widget template objects included in the model map 420. In an embodiment, the similarity map generator 431 may generate a similarity map indicating similarity between context (or an attribute and/or a prompt) of each of the plurality of widget template objects and context (or an attribute and/or a prompt) of the widget 240. In an embodiment, the similarity map generator 431 may generate a similarity map indicating similarity between context of each of one or more objects included in each of the plurality of widget template objects and context of each of the one or more objects 241, 243, and 245 included in the widget 240. For example, similarity of a widget template object including a background image of a size similar to a changed size of the object 241, which is a background image, may have a high similarity. For example, similarity of a widget template object including an information element that has an attribute similar to attributes (e.g., English, a date, a size of a text, and a font) included in the object 243, which is an information element, may have a high similarity. For example, similarity of a widget template object including an information element that has an attribute similar to attributes (e.g., an English month, a number, an English day of the week, a calendar, a size of a text, an icon, and a font) included in the object 245, which is an information element, may have a high similarity.

In an embodiment, the similarity map generator 431 may generate a similarity map through a convolution calculation between each of the plurality of widget template objects and the widget 240.

In an embodiment, the corrector 435 may select one widget template object from among the plurality of widget template objects based on the similarity map. In an embodiment, the corrector 435 may select one widget template object from among the plurality of widget template objects based on a similarity map including one or more similarities, by using the template set selector 461. In an embodiment, the template set selector 461 may select one widget template object having similarity greater than or equal to a reference similarity from among the plurality of widget template objects. For example, the template set selector 461 may select one widget template object including one or more objects, in which similarity of each of the one or more objects 241, 243, and 245 included in the widget 240 is greater than or equal to a reference similarity, from among the plurality of widget template objects. For example, similarity for an object may include similarity based on a position of the object, similarity based on a type of the object, and/or similarity based on an attribute of the object.

In an embodiment, the template set selector 461 may select a widget template object having the highest similarity from among the plurality of widget template objects. In an embodiment, the template set selector 461 may be based on an operation or algorithm (e.g., a Hopcroft-Karp algorithm) for selecting one template object from among the plurality of widget template objects. However, embodiments of the present disclosure are not limited thereto.

In an embodiment, the corrector 435 may relocate the objects 241, 243, and 245 included in the widget 240 based on the selected widget template object. In an embodiment, the corrector 435 may relocate the objects 241, 243, and 245 included in the widget 240 based on position information of one or more objects included in the selected widget template object, using the widget generator 463. In an embodiment, the corrector 435 may relocate each of the objects 241, 243, and 245 based on position information of an object included in the widget template object having the highest similarity for each of the objects 241, 243, and 245 included in the widget 240. For example, the corrector 435 may relocate the object 243 to a position on the widget, in which a size is adjusted, corresponding to the position of the object included in the widget template object having the highest similarity. In an embodiment, the widget generator 463 may be based on an operation or algorithm (e.g., gradient magnitude similarity deviation) for relocating each of the objects 241, 243, and 245. However, embodiments of the present disclosure are not limited thereto.

In an embodiment, the corrector 435 may change the attribute of the objects 241, 243, and 245 included in the widget 240 based on the selected widget template object. In an embodiment, the corrector 435 may change the attribute of the objects 241, 243, and 245 based on an attribute of objects included in the selected widget template object. For example, the corrector 435 may change the attribute of the object 243 based on an attribute of an object corresponding to the object 243 among the objects included in the selected widget template object. For example, the widget synthesizer 230 may reduce a size of a text of the object 243 in a case that a size of a text according to the attribute of the object corresponding to the object 243 included in the selected widget template object is smaller than a size of a text according to the attribute of the object 243.

In an embodiment, the corrector 435 may generate a relocated widget 409 by relocating each of the objects 241, 243, and 245 to a position on the widget, in which a size is adjusted, corresponding to the position of the object included in the widget template object having the highest similarity. In an embodiment, the relocated widget 409 may correspond to the widget 250 according to FIG. 2C and/or the widget 270 according to FIG. 2D.

As an electronic device 101 as described above relocates the objects 241, 243, and 245 included in the widget 240 according to a change in a size of the widget 240, the number of widget sizes that APP developers should implement for a user experience may be reduced. Accordingly, resource consumption for implementing a widget of various sizes by the APP developers may be reduced. The electronic device 101 as described above may reduce breakage (e.g., overlap between objects or loss of information) of the objects 241, 243, and 245 by relocating the objects 241, 243, and 245 included in the widget 240 according to a change in a size of the widget 240. Accordingly, discomfort of a user of the electronic device 101 caused by the breakage of the objects 241, 243, and 245 may be reduced.

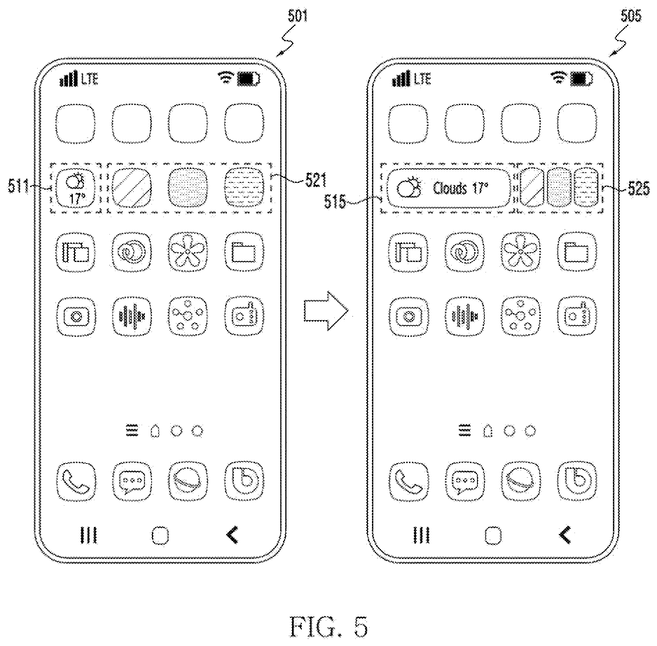

FIG. 5 illustrates an example of screens 501 and 505 according to an embodiment. FIG. 5 may be described with reference to FIGS. 1 to 4C.

In an embodiment, an electronic device 101 may display a screen 501 including widgets 511 and 521. In an embodiment, the electronic device 101 may obtain an input for horizontally enlarging the widget 511. In an embodiment, the electronic device 101 may obtain an input for changing a size of the widget 511 from 1-by-1 to 3-by-1.

In an embodiment, the electronic device 101 may identify an asset of the widget 511 based on the input. In an embodiment, the electronic device 101 may identify an asset corresponding to a size and/or a ratio of the changed widget 511 based on the input. In an embodiment, the electronic device 101 may identify an asset of the widget 511 having a size of 3 by 1 based on the input. Herein, the asset may include information on one or more objects included in the widget according to a designated size of the widget. The information on the one or more objects may include information on a position of the objects and/or an attribute (e.g., an information element, a management element, a text type, a size of a text, or a type of an image) of the objects.

In an embodiment, in a case that an asset is identified based on an input, the electronic device 101 may generate a widget 515 based on the asset. In an embodiment, in a case that an asset is not identified based on an input, the electronic device 101 may generate the widget 515 based on a widget synthesizer 230. Referring to FIG. 5, as the widget 511 is horizontally enlarged on the screen 501, the widget 511 may be changed to the widget 515. Compared with the widget 511, the widget 515 of the screen 505 may change a position of an icon (e.g., cloud) and a text (e.g., 17 degrees) in the widget. Compared with the widget 511, a new object (e.g., “clouds”) may be added to the widget 515. Herein, the new object (e.g., “clouds”) may be added to the widget 515 in a case of being defined in the asset. In addition, the new object (e.g., “clouds”) may be added to the widget 515 in a case of being defined in a widget template object that has objects with high similarity to objects included in the widget 511.

In an embodiment, the electronic device 101 may identify the widget 521 in which a size and/or a ratio are changed based on the input for horizontally enlarging the widget 511.

In an embodiment, in a case that the widget 521 in which a size and/or a ratio a changed is identified, the electronic device 101 may identify an asset corresponding to a size and/or a ratio of the changed widget 521.

In an embodiment, in a case that an asset is identified based on an input, the electronic device 101 may generate a widget 521 based on the asset. In an embodiment, in a case that an asset is not identified based on an input, the electronic device 101 may generate the widget 521 based on the widget synthesizer 230.

As described above, in a case that a size and/or a ratio of the widget 511 or 521 is changed by not only a direct input to the widget 511 but also an indirect input to the widget 521, the electronic device 101 may generate new widgets 515 and 525 through the widget synthesizer 230. Accordingly, as the electronic device 101 newly generates all the widgets 515 and 525 affected by an input, it may reduce a user's discomfort that may occur from the widgets 515 and 525 being broken.

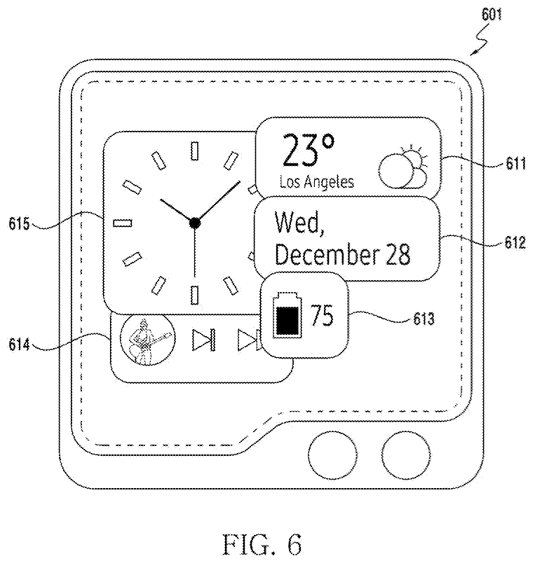

FIG. 6 illustrates an example of a screen 601 according to an embodiment. FIG. 6 may be described with reference to FIGS. 1 to 5.

In an embodiment, an electronic device 101 may display the screen 601 including widgets 611, 612, 613, 614, and 615. In an embodiment, the electronic device 101 may display, on the screen 601, at least some widgets among the widgets 611, 612, 613, 614, and 615 by overlapping at least a portion of them with each other.

Compared to FIG. 5, in a case of FIG. 6, based on an input for changing a size and/or a ratio of one widget among the widgets 611, 612, 613, 614, and 615, the electronic device 101 may not change a size and/or a ratio of other widgets overlapping with the one widget.

Accordingly, based on the input, the electronic device 101 may generate a new widget from the one widget based on an asset and/or a widget synthesizer 230.

As described above, in a case of managing the screen 601 of a display 260 without a lattice structure, the electronic device 101 may prevent a size and/or a ratio of a widget from being changed by an indirect input to the widget. Accordingly, a user may prevent a size and/or a ratio of the widget from being changed unintentionally by an input.

FIG. 7 illustrates an example of screens 701 and 703 according to an embodiment. FIG. 7 may be described with reference to FIGS. 1 to 4C.

FIG. 7 may indicate an example of changing a size and/or a ratio of a widget 240 as a size of the screen 701 or 703 is changed. For example, a change in the size of the screen 701 or 703 may occur in a case that a size of a display 260 is changed as an electronic device 101 is a rollable (or foldable) device. For example, a change in the size of the screen 701 or 703 may occur in a case that a user changes (or transfers) the electronic device 101 to another electronic device 102. However, embodiments of the present disclosure are not limited thereto. For example, a change in the size of the screen 701 or 703 may occur in a case that the number of screens displayed on the display 260 is changed. For example, in a situation where one screen is displayed through the display 260, when two or more screens are displayed at the same time, a size and/or a ratio occupied by each of the two or more screens may be changed. For example, a change in the size of the screen 701 or 703 may occur in a case that a mode of a screen displayed on the display 260 is changed. In a case that the screen is displayed in a horizontal mode through the display 260, when the electronic device 101 is vertically changed, a horizontal-vertical ratio of the screen may be changed as the screen is displayed in a vertical mode.

In an embodiment, the electronic device 101 may identify that the size of the screen 701 or 703 is changed. In an embodiment, the electronic device 101 may identify an asset of the widget 240 based on identifying that the size of the screen 701 or 703 is changed. In an embodiment, the electronic device 101 may identify an asset corresponding to the changed size and/or ratio of the widget 240 based on identifying that the size of the screen 701 or 703 is changed.

In an embodiment, in a case that an asset is identified based on identifying that the size of the screen 701 or 703 is changed, the electronic device 101 may generate the widget 240 in which a size and/or a ratio are changed based on the asset. In an embodiment, in a case that an asset is not identified based on identifying that the size of the screen 701 or 703 is changed, the electronic device 101 may generate the widget 240 in which a size and/or a ratio are changed based on a widget synthesizer 230.

As described above, not only in a case of a direct input to a widget 511but also in a case that the size and/or the ratio of the screen of the display 260 is changed, the electronic device 101 may generate a new widget 240 through the widget synthesizer 230. Accordingly, even when the size and/or ratio of the screen of the display 260 is changed, the widget 240 may be stably displayed without being broken.

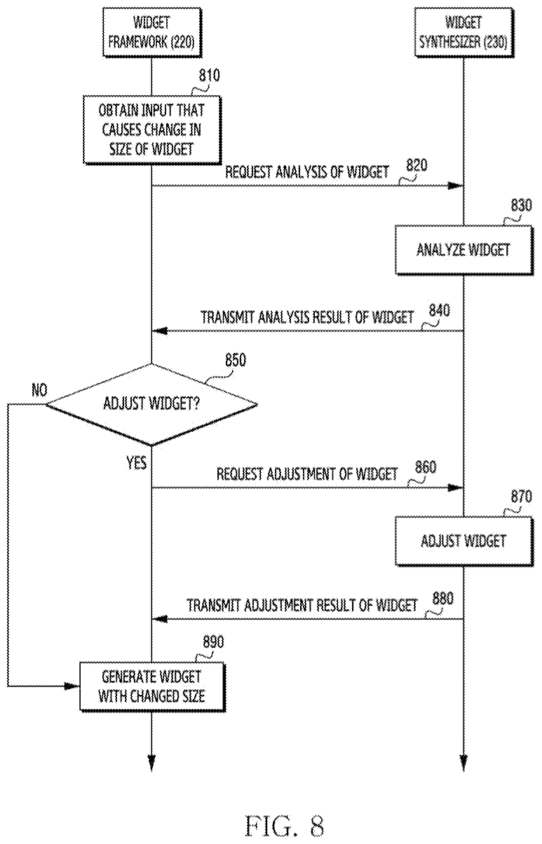

FIG. 8 is a flowchart indicating an operation of an electronic device according to an embodiment. FIG. 8 may be described with reference to FIGS. 1 to 4C.

Referring to FIG. 8, in operation 810, a widget framework 220 may obtain an input that causes a change in a size of a widget 240. Herein, the input that causes a change in the size of the widget 240 may include an input for changing a lattice structure of a screen 265 of a display 260. For example, the input that causes a change in the size of the widget 240 may include an input to another widget other than the widget 240 that causes a change in the size of the widget 240. For example, as the input to the other widget is moved in a direction of the widget 240, the size of the widget 240 may be changed.

In operation 820, the widget framework 220 may request analysis of the widget 240. In an embodiment, the widget framework 220 may request analysis of the widget 240 based on the size of the widget 240 being changed by an input. In an embodiment, the request of the widget framework 220 may include information on an input event and/or information on the widget 240 to which the input is inputted. For example, the information on the input event may indicate whether a size and/or a grid of the widget 240 have been changed.

In operation 830, a widget synthesizer 230 may analyze the widget 240. In an embodiment, the widget synthesizer 230 may analyze objects 241, 243, and 245 in the widget 240.

In an embodiment, the widget synthesizer 230 may extract (or identify) the objects 241, 243, and 245 from the widget 240. In an embodiment, the widget synthesizer 230 may analyze (or identify) context of each of the objects 241, 243, and 245 of the widget 240. In an embodiment, a widget analyzer 231 may analyze a prompt for the objects 241, 243, and 245 of the analyzed (or identified) widget 240. In an embodiment, the widget synthesizer 230 may calculate (or identify) size information and/or position information of each of the objects 241, 243, and 245 of the widget 240.

In operation 840, the widget synthesizer 230 may transmit an analysis result of the widget 240. In an embodiment, the widget analyzer 231 may transmit an attribute of an object for the objects 241, 243, and 245 of the widget 240 extracted from an object extractor 310, an attribute of one or more elements included in the object, a type of elements, a prompt of the object, and/or size information and/or position information of the object to the widget framework 220.

In operation 850, the widget framework 220 may determine whether adjustment of the widget 240 is required. In an embodiment, the widget framework 220 may determine whether adjustment of the widget 240 is required based on size information and/or position information of the objects 241, 243, and 245 included in the widget 240. In an embodiment, the widget framework 220 may determine whether adjustment of the widget 240 is required based on a size of a text and/or a size of an image of the objects 241, 243, and 245 included in the widget 240.

For example, according to a change in the size of the widget 240, in a case that overlapping for at least one object of the objects 241, 243, and 245, and/or loss of information occur, the widget framework 220 may identify that adjustment of the widget 240 is required. For example, according to a change in the size of the widget 240, in a case that overlapping for all of the objects 241, 243, and 245, and/or loss of information do not occur, the widget framework 220 may identify that adjustment of the widget 240 is not required. For example, in a case that an asset corresponding to the changed size of the widget 240 exists, the widget framework 220 may identify that adjustment of the widget 240 is not required.

As a result of the determination of the operation 850, in a case that adjustment of the widget 240 is required, the widget framework 220 may perform operation 860. As a result of the determination of the operation 850, in a case that adjustment of the widget 240 is not required, the widget framework 220 may perform operation 890.

In the operation 860, the widget framework 220 may request adjustment of the widget 240. In an embodiment, the widget framework 220 may request a widget host 221 to adjust the widget 240. In an embodiment, the adjustment request may include the context for the objects 241, 243, and 245 of the widget 240. In an embodiment, the adjustment request may include an attribute of an object for the objects 241, 243, and 245 of the widget 240, an attribute of one or more elements included in the object, a type of the elements, a prompt of the object, and/or size information and/or position information of the object. In an embodiment, the adjustment request may include information on the changed size of the widget 240.

In operation 870, the widget synthesizer 230 may adjust the widget 240.

In an embodiment, the widget synthesizer 230 may perform image processing for the objects 241, 243, and 245 in the widget 240. In an embodiment, the widget synthesizer 230 may perform image processing for the objects 241, 243, and 245 in the widget 240 in response to a request of the widget framework 220. In an embodiment, the widget synthesizer 230 may change a size of a frame of each of the objects 241, 243, and 245 in the widget 240. In an embodiment, the widget synthesizer 230 may perform image processing for an image object among the objects 241, 243, and 245 in the widget 240. In an embodiment, the widget synthesizer 230 may perform image processing for the objects 241, 243, and 245 such that the image object is drawn in the changed frame. In an embodiment, the widget synthesizer 230 may perform image processing for the image object based on context of the image object of the widget 240. In an embodiment, the widget synthesizer 230 may perform at least one of enlargement, reduction, cropping, or out-painting for the image object. In an embodiment, the widget synthesizer 230 may perform at least one of enlargement, reduction, cropping, or out-painting for the image object based on the context of the image object of the widget 240.

In an embodiment, the widget synthesizer 230 may identify a widget template object for locating the objects 241, 243, and 245 among a plurality of widget template objects. In an embodiment, the widget synthesizer 230 may relocate the objects 241, 243, and 245 based on the selected widget template object. In an embodiment, the widget synthesizer 230 may relocate the objects 243 and 245 on the object 241, which is a background image of the image-processed widget 240, based on the selected widget template object.

In an embodiment, the widget synthesizer 230 may change an attribute of the objects 241, 243, and 245 included in the widget 240 based on the selected widget template object. In an embodiment, the widget synthesizer 230 may change the attribute of the objects 241, 243, and 245 based on an attribute of objects included in the selected widget template object. For example, the widget synthesizer 230 may change the attribute of the object 243 based on an attribute of an object corresponding to the object 243 among the objects included in the selected widget template object.

In operation 880, the widget synthesizer 230 may transmit an adjustment result of the widget 240. In an embodiment, the widget synthesizer 230 may transmit the adjustment result of the widget 240 to the widget framework 220. In an embodiment, the adjustment result may include information on the changed attribute of the objects 241, 243, and 245 included in the widget 240. In an embodiment, the adjustment result may include the changed position information and/or size information of the objects 241, 243, and 245 included in the widget 240. Herein, the information on the changed attribute may include an attribute (e.g., a text size, a text type, an icon, or an image) of one or more elements included in the object, and a type (e.g., a calendar, a person, a face 247, a hand 248, a flower basket 249, weather information, an item, or an animal) of the elements.

In operation 890, the widget framework 220 may generate the widget 240 with the changed size.

In an embodiment, the widget framework 220 may generate the widget 240 with the changed size based on an asset of the widget 240. Herein, the asset may include information on one or more objects included in a widget according to a designated size of the widget. The information on the one or more objects may include information on a position of the objects and/or an attribute (e.g., an information element, a management element, a text type, a size of a text, or a type of an image) of the objects.

In an embodiment, the widget framework 220 may generate the widget 240 with the changed size based on the adjustment result of the widget 240. In an embodiment, the widget framework 220 may generate the widget 240 with the changed size based on information on a position of objects included in the adjustment result and/or an attribute (e.g., an information element, a management element, a text type, a size of a text, or a type of an image) of the objects.

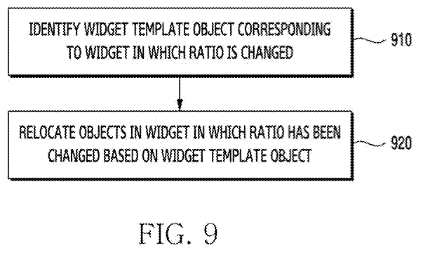

FIG. 9 is a flowchart indicating an operation of an electronic device according to an embodiment. FIG. 9 may be described with reference to FIGS. 1 to 4C and 8. Operations of FIG. 9 may be included in the operation 870 of FIG. 8.

Referring to FIG. 9, in operation 910, a widget synthesizer 230 may identify a widget template object corresponding to a widget 240 in which a size is changed.

In an embodiment, the widget synthesizer 230 may generate a similarity map indicating similarity between the widget 240 and a plurality of widget template objects included in a model map 420. In an embodiment, the widget synthesizer 230 may generate a similarity map indicating similarity between context (or an attribute and/or a prompt) of each of the plurality of widget template objects and context (or an attribute and/or a prompt) of the widget 240. In an embodiment, the widget synthesizer 230 may generate a similarity map indicating similarity between context of each of one or more objects included in each of the plurality of widget template objects and context of each of one or more objects 241, 243, and 245 included in the widget 240. For example, similarity of a widget template object including a background image of a size similar to a changed size of the object 241, which is a background image, may have a high similarity. For example, similarity of a widget template object including an information element that has an attribute similar to attributes (e.g., English, a date, a size of a text, and a font) included in the object 243, which is an information element, may have a high similarity. For example, similarity of a widget template object including an information element that has an attribute similar to attributes (e.g., an English month, a number, an English day of the week, a calendar, a size of a text, an icon, and a font) included in the object 245, which is an information element, may have a high similarity.

In an embodiment, the widget synthesizer 230 may select one widget template object from among the plurality of widget template objects based on the similarity map. In an embodiment, the widget synthesizer 230 may select one widget template object from among the plurality of widget template objects based on a similarity map including one or more similarities, by using a template set selector 461. In an embodiment, the widget synthesizer 230 may select one widget template object having similarity greater than or equal to a reference similarity from among the plurality of widget template objects. In an embodiment, the widget synthesizer 230 may select one widget template object having the highest similarity from among the plurality of widget template objects. In an embodiment, the widget synthesizer 230 may be based on an operation or algorithm (e.g., a Hopcroft-Karp algorithm) for selecting one template object from among the plurality of widget template objects. However, embodiments of the present disclosure are not limited thereto.

In operation 920, the widget synthesizer 230 may relocate objects in the widget 240 in which a size has been changed based on the widget template object.

In an embodiment, the widget synthesizer 230 may relocate the objects 241, 243, and 245 included in the widget 240 based on the selected widget template object. In an embodiment, the widget synthesizer 230 may relocate the objects 241, 243, and 245 included in the widget 240 based on position information of one or more objects included in the selected widget template object, by using a widget generator 463. In an embodiment, the widget synthesizer 230 may relocate each of the objects 241, 243, and 245 based on position information of an object included in a widget template object having the highest similarity for each of the objects 241, 243, and 245 included in the widget 240. For example, the widget synthesizer 230 may relocate the object 243 to a position on the widget, in which a size is adjusted, corresponding to the position of the object included in the widget template object having the highest similarity. In an embodiment, the widget synthesizer 230 may be based on an operation or algorithm (e.g., gradient magnitude similarity deviation) for relocating each of the objects 241, 243, and 245. However, embodiments of the present disclosure are not limited thereto.

In the operation 910, it has been described that the widget template object is identified without considering presence or absence of the asset, but it is merely an example. In an embodiment, the widget synthesizer 230 may identify an asset having a size closest to the changed size of the widget 240. In an embodiment, the widget synthesizer 230 may identify one or more other objects included in the identified asset. In an embodiment, the widget synthesizer 230 may identify similarity between each of the plurality of widget template objects and the identified asset. Herein, the similarity may include similarity between attributes of the one or more other objects included in the asset and attributes of one or more objects included in each of the plurality of widget template objects.

In an embodiment, the widget synthesizer 230 may identify a widget template object having similarity greater than or equal to a reference similarity among the plurality of widget template objects. In an embodiment, the widget synthesizer 230 may relocate the other object to a widget 250 or 270 in which a size is changed, based on the identified widget template object. In an embodiment, the widget synthesizer 230 may include one or more objects added to the asset identified based on the widget 240 in the changed widget 250 or 270.

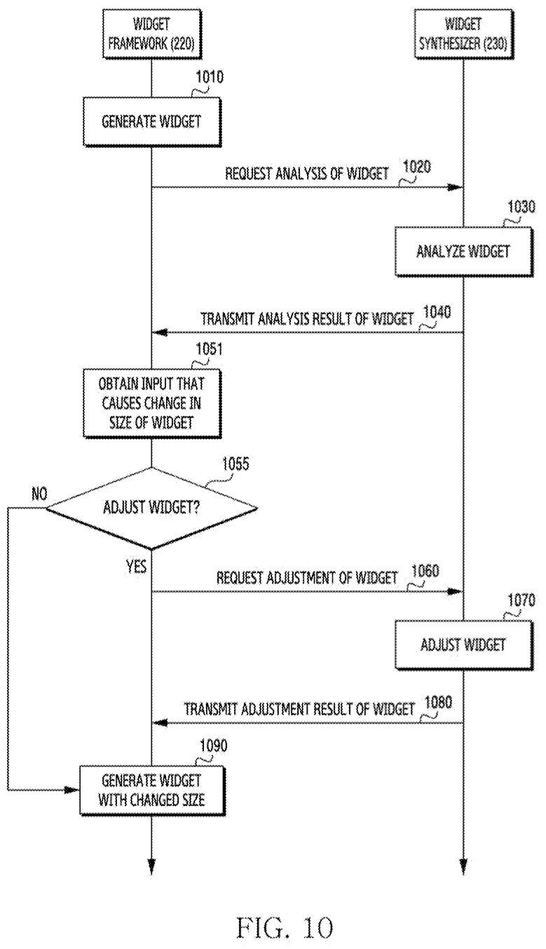

FIG. 10 is a flowchart indicating an operation of an electronic device according to an embodiment. FIG. 10 may be described with reference to FIGS. 1 to 4C, 8, and 9.

Operation 1020 of FIG. 10 may correspond to the operation 820 of FIG. 8. Operation 1030 of FIG. 10 may correspond to the operation 830 of FIG. 8. Operation 1040 of FIG. 10 may correspond to the operation 840 of FIG. 8. Operation 1055 of FIG. 10 may correspond to the operation 850 of FIG. 8. It may correspond to the operation 840 of FIG. 8. Operation 1060 of FIG. 10 may correspond to the operation 860 of FIG. 8. Operation 1070 of FIG. 10 may correspond to the operation 870 of FIG. 8. Operation 1080 of FIG. 10 may correspond to the operation 880 of FIG. 8. Operation 1090 of FIG. 10 may correspond to the operation 890 of FIG. 8.

Compared with FIG. 8, in FIG. 10, analysis of a widget 240 may be performed at a time when the widget 240 is generated to be displayed on a display 260.

Referring to FIG. 10, in operation 1010, a widget framework 220 may generate the widget 240. In an embodiment, the widget framework 220 may generate the widget 240 based on a request for an application 146 associated with the widget 240. In an embodiment, the widget framework 220 may generate the widget 240 based on an input requesting the generation of the widget 240 on a screen (e.g., a screen 265 of a home screen APP 211 and/or a lock screen APP 215).

In operation 1020, the widget framework 220 may request analysis of the widget 240. In the operation 1030, a widget synthesizer 230 may analyze the widget 240. In the operation 1040, the widget synthesizer 230 may transmit an analysis result of the widget 240.

In operation 1051, the widget framework 220 may obtain an input that causes a change in a size of the widget 240. In operation 1055, the widget framework 220 may determine whether adjustment of the widget 240 is required. As a result of the determination of the operation 1055, in a case that adjustment of the widget 240 is required, the widget framework 220 may perform the operation 1060. As a result of the determination of the operation 1055, in a case that adjustment of the widget 240 is not required, the widget framework 220 may perform the operation 1090.

In operation 1060, the widget framework 220 may request adjustment of the widget 240. In the operation 1070, the widget synthesizer 230 may adjust the widget 240. In the operation 1080, the widget synthesizer 230 may transmit an adjustment result of the widget 240. In the operation 1090, the widget framework 220 may generate the widget 240 with the changed size.

As described above, an electronic device 101 may generate the widget 240 with the changed size more quickly in response to an input for changing the size of the widget 240 by a user, by analyzing the widget 240 when generating the widget 240.

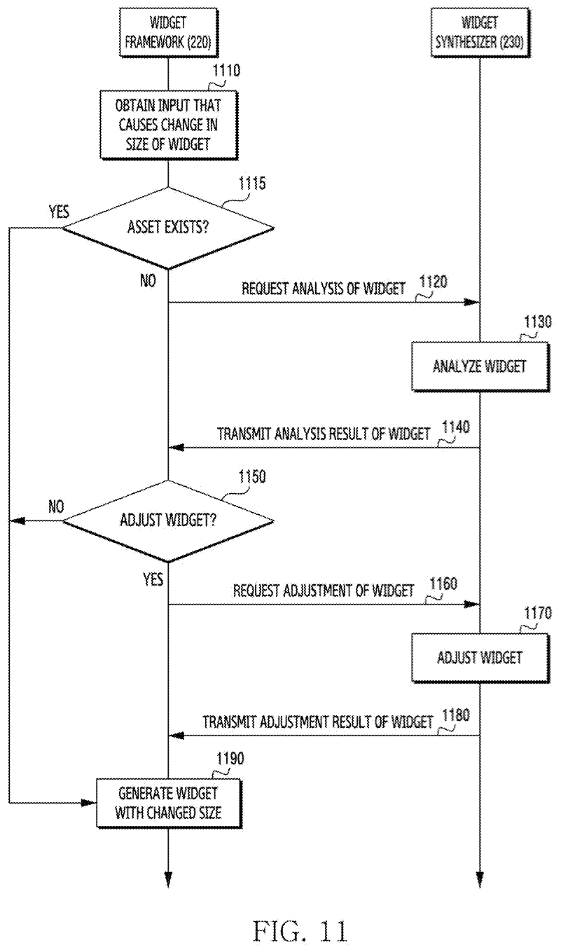

FIG. 11 is a flowchart indicating an operation of an electronic device according to an embodiment. FIG. 11 may be described with reference to FIGS. 1 to 4C, 8, and 10.

Operation 1110 of FIG. 11 may correspond to the operation 810 of FIG. 8. Operation 1120 of FIG. 11 may correspond to the operation 820 of FIG. 8. Operation 1130 of FIG. 11 may correspond to the operation 830 of FIG. 8. Operation 1140 of FIG. 11 may correspond to the operation 840 of FIG. 8. Operation 1150 of FIG. 11 may correspond to the operation 850 of FIG. 8. It may correspond to the operation 840 of FIG. 8. Operation 1160 of FIG. 11 may correspond to the operation 860 of FIG. 8. Operation 1170 of FIG. 11 may correspond to the operation 870 of FIG. 8. Operation 1180 of FIG. 11 may correspond to the operation 880 of FIG. 8. Operation 1190 of FIG. 11 may correspond to the operation 890 of FIG. 8.

Referring to FIG. 11, in the operation 1110, a widget framework 220 may obtain an input that causes a change in a size of a widget 240.

In operation 1115, the widget framework 220 may identify whether an asset exists. In an embodiment, the widget framework 220 may identify whether an asset corresponding to the changed size of the widget 240 exists.

As a result of the determination of the operation 1115, in a case that an asset does not exist, the widget framework 220 may perform the operation 1120. As a result of the determination of the operation 1115, in a case that an asset exists, the widget framework 220 may perform the operation 1090.

In the operation 1120, the widget framework 220 may request analysis of the widget 240. In the operation 1130, a widget synthesizer 230 may analyze the widget 240. In the operation 1140, the widget synthesizer 230 may transmit an analysis result of the widget 240. In the operation 1150, the widget framework 220 may determine whether adjustment of the widget 240 is required. As a result of the determination of the operation 1150, in a case that adjustment of the widget 240 is required, the widget framework 220 may perform the operation 1160. As a result of the determination of the operation 1150, in a case that adjustment of the widget 240 is not required, the widget framework 220 may perform the operation 1190.

In the operation 1160, the widget framework 220 may request adjustment of the widget 240. In the operation 1170, the widget synthesizer 230 may adjust the widget 240. In the operation 1180, the widget synthesizer 230 may transmit an adjustment result of the widget 240. In the operation 1190, the widget framework 220 may generate the widget 240 with the changed size.

As described above, in a case that an asset corresponding to the changed size of the widget 240 when the size of the widget 240 is changed exists, the electronic device 101 may prevent unnecessary analysis of the widget 240 by generating the widget 240 based on the asset.

An electronic device 101 as described above may include a display 160 or 260. The electronic device 101 may include a processor 120. The electronic device 101 may include memory 130 storing instructions. The instructions may be configured, when executed by the processor 120, to cause the electronic device 101 to identify an input that causes a change in a size of a widget 240 displayed on a designated screen 265 of the display 160 or 260. The instructions may be configured, when executed by the processor 120, to cause the electronic device 101 to, in response to the input, change the size of the widget 240. The instructions may be configured, when executed by the processor 120, to cause the electronic device 101 to identify a widget template object corresponding to the changed size of the widget 240 and first attributes of one or more first objects 241, 243, 245, 247, 248, and 249 included in the widget 240. The instructions may be configured, when executed by the processor 120, to cause the electronic device 101 to, based on the identified widget template object, relocate the one or more first objects 241, 243, 245, 247, 248, and 249 to the resized widget 250 or 270. The instructions may be configured, when executed by the processor 120, to cause the electronic device 101 to display the resized widget 250 or 270 including the one or more first relocated objects 241, 243, 245, 247, 248, and 249 on the designated screen 265.

The input may be an input for causing a change in a lattice structure of the designated screen 265. The input may be an input to the widget 240 for causing a change in the size of the widget 240.

The instructions may be configured, when executed by the processor 120, to cause the electronic device 101 to, by inputting data regarding the changed size, the widget 240, and the first attributes of the one or more first objects 241, 243, 245, 247, 248, and 249 into an artificial intelligence (AI) model, identify the widget template object. The AI model may be trained based on a plurality of widget template objects in which one or more second objects having second attributes are located to output the widget template object indicating location information of the one or more first objects 241, 243, 245, 247, 248, and 249 based on the changed size, the widget 240, and the attributes of the one or more first objects 241, 243, 245, 247, 248, and 249.

The instructions may be configured, when executed by the processor 120, to cause the electronic device 101 to identify similarity between each of a plurality of widget template objects and the widget 240. The similarity may include similarity between the first attributes of the one or more first objects included in the widget and second attributes of one or more second objects included in each of the plurality of widget template objects. The instructions may be configured, when executed by the processor 120, to cause the electronic device 101 to identify the widget template object of which the similarity is greater than or equal to a reference similarity among the plurality of widget template objects.

The instructions may be configured, when executed by the processor 120, to cause the electronic device 101 to, based on the input, identify whether an asset for the changed size of the widget 240 exists.

The instructions may be configured, when executed by the processor 120, to cause the electronic device 101 to, in response to that the asset is identified, relocate the one or more first objects 241, 243, 245, 247, 248, and 249 to the resized widget 250 or 270 based on the identified asset. The instructions may be configured, when executed by the processor 120, to cause the electronic device 101 to, in response to that the asset is not identified, relocate the one or more first objects 241, 243, 245, 247, 248, and 249 to the resized widget 250 or 270 based on the identified widget template object.

The instructions may be configured, when executed by the processor 120, to cause the electronic device 101 to, based on the input, identify another asset with a size closest to the changed size of the widget 240. The instructions may be configured, when executed by the processor 120, to cause the electronic device 101 to identify the widget template object corresponding to the changed size of the widget 240 and the first attributes of the one or more first objects 241, 243, 245, 247, 248, and 249 included in the other asset.

The instructions may be configured, when executed by the processor 120, to cause the electronic device 101 to identify the first attributes of the one or more first objects 241, 243, 245, 247, 248, and 249 included in the widget 240. The instructions may be configured, when executed by the processor 120, to cause the electronic device 101 to, based on the first attributes, identify at least one first object among the one or more first objects 241, 243, 245, 247, 248, and 249 that is outside a frame of the widget 240 according to a change in the size of the widget 240. The instructions may be configured, when executed by the processor 120, to cause the electronic device 101 to, based on that the at least one first object is not identified, adjust a size of the one or more first objects 241, 243, 245, 247, 248, and 249 according to the change in the size of the widget 240 without relocating the one or more first objects 241, 243, 245, 247, 248, and 249. The instructions may be configured, when executed by the processor 120, to cause the electronic device 101 to, based on that the at least one first object is identified, relocate the one or more first objects 241, 243, 245, 247, 248, and 249 to the resized widget 250 or 270.

The first attributes may be obtained at the time when the widget 240 is generated to be displayed on the display 160 or 260, or may be obtained in response to the input.

The instructions may be configured, when executed by the processor 120, to cause the electronic device 101 to, in response to the input, identify that the size of the widget 240 is changed. The instructions may be configured, when executed by the processor 120, to cause the electronic device 101 to, in response to the change in the size of the widget 240, generate a new background image by cropping and/or out-painting a background image of the widget 240. The instructions may be configured, when executed by the processor 120, to cause the electronic device 101 to relocate the one or more first objects on the new background image of the resized widget 250 or 270.

The instructions may be configured, when executed by the processor 120, to cause the electronic device 101 to identify a prompt associated with the changed size, the widget 240, and the one or more objects. It may cause the electronic device 101 to, by inputting the prompt into a generative artificial intelligence (AI) model, generate the new background image.

The instructions may be configured, when executed by the processor 120, to cause the electronic device 101 to identify a type of the one or more first objects 241, 243, 245, 247, 248, and 249 included in the widget 240 based on data to which a designated type of noise is added to a layout of the widget 240. The instructions may be configured, when executed by the processor 120, to cause the electronic device 101 to, based on the type of the one or more first objects 241, 243, 245, 247, 248, and 249, identify the widget template object.

The instructions may be configured, when executed by the processor 120, to cause the electronic device 101 to, based on the input, identify an asset with a size closest to the changed size of the widget 240. The instructions may be configured, when executed by the processor 120, to cause the electronic device 101 to identify another object included in the identified asset. The instructions may be configured, when executed by the processor 120, to cause the electronic device 101 to identify other similarity between each of the plurality of widget template objects and the asset. The other similarity may include similarity between the first attributes of other objects included in the asset and the second attributes of the one or more second objects. The instructions may be configured, when executed by the processor 120, to cause the electronic device 101 to identify a widget template object of which the other similarity is greater than or equal to a reference similarity among the plurality of widget template objects. The instructions may be configured, when executed by the processor 120, to cause the electronic device 101 to relocate the other object to the resized widget 250 or 270 based on the identified widget template object. The instructions may be configured, when executed by the processor 120, to cause the electronic device 101 to display the resized widget 250 or 270 including the relocated other object on the designated screen 265.

A method as described above may be executed by an electronic device 101 including a display 160 or 260. The method may include identifying an input that causes a change in a size of a widget 240 displayed on a designated screen 265 of the display 160 or 260. The method may include, in response to the input, changing the size of the widget 240. The method may include identifying a widget template object corresponding to the changed size of the widget 240 and first attributes of one or more first objects 241, 243, 245, 247, 248, and 249 included in the widget 240. The method may include, based on the identified widget template object, relocating the one or more first objects 241, 243, 245, 247, 248, and 249 to the resized widget 250 or 270. The method may include displaying the resized widget 250 or 270 including the one or more first relocated objects 241, 243, 245, 247, 248, and 249 on the designated screen 265.

The input may be an input for causing a change in a lattice structure of the designated screen 265. The input may be an input to the widget 240 for causing a change in the size of the widget 240.

The method may include, by inputting data regarding the changed size, the widget 240, and the first attributes of the one or more first objects 241, 243, 245, 247, 248, and 249 into an artificial intelligence (AI) model, identifying the widget template object. The AI model may be trained based on a plurality of widget template objects in which one or more second objects having second attributes are located to output the widget template object indicating location information of the one or more first objects 241, 243, 245, 247, 248, and 249 based on the widget 240 and the attributes of the one or more first objects 241, 243, 245, 247, 248, and 249.

The method may include identifying similarity between each of a plurality of widget template objects and the widget 240. The similarity may include similarity between the first attributes of the one or more first objects included in the widget and second attributes of one or more second objects included in each of the plurality of widget template objects. The method may include identifying the widget template object of which the similarity is greater than or equal to a reference similarity among the plurality of widget template objects.

The method may include, based on the input, identifying whether an asset for the changed size of the widget 240 exists. The method may include, in response to that the asset is identified, relocating the one or more first objects 241, 243, 245, 247, 248, and 249 to the resized widget 250 or 270 based on the identified asset. The method may include, in response to that the asset is not identified, relocating the one or more first objects 241, 243, 245, 247, 248, and 249 to the resized widget 250 or 270 based on the identified widget template object.

The method may include identifying the first attributes of the one or more first objects 241, 243, 245, 247, 248, and 249 included in the widget 240. The method may include, based on the first attributes, identifying at least one first object among the one or more first objects 241, 243, 245, 247, 248, and 249 that is outside a frame of the widget 240 according to a change in the size of the widget 240. The method may include, based on that the at least one first object is not identified, adjusting a size of the one or more first objects 241, 243, 245, 247, 248, and 249 according to the change in the size of the widget 240 without relocating the one or more first objects 241, 243, 245, 247, 248, and 249. The method may include, based on that the at least one first object is identified, relocating the one or more first objects 241, 243, 245, 247, 248, and 249 to the resized widget 250 or 270.

The first attributes may be obtained at the time when the widget 240 is generated to be displayed on the display 160 or 260, or may be obtained in response to the input.

The method may include, in response to the input, identifying that the size of the widget 240 is changed. The method may include, in response to the change in the size of the widget 240, generating a new background image by cropping and/or out-painting a background image of the widget 240. The method may include relocating the one or more first objects on the new background image of the resized widget 250 or 270.

The method may include identifying a prompt associated with the changed size, the widget 240, and the one or more objects. The method may include, by inputting the prompt into a generative artificial intelligence (AI) model, generating the new background image.

The method may include identifying a type of the one or more first objects 241, 243, 245, 247, 248, and 249 included in the widget 240 based on data to which a designated type of noise is added to a layout of the widget 240. The method may include, based on the type of the one or more first objects 241, 243, 245, 247, 248, and 249, identifying the widget template object.

A non-transitory computer readable storage medium as described above may store a program including instructions. The instructions may be configured, when executed by a processor 120 of an electronic device 101 including a display 160 or 260, to cause the electronic device 101 to identify an input that causes a change in a size of a widget 240 displayed on a designated screen 265 of the display 160 or 260. The instructions may be configured, when executed by the processor 120, to cause the electronic device 101 to, in response to the input, change the size of the widget 240. The instructions may be configured, when executed by the processor 120, to cause the electronic device 101 to identify a widget template object corresponding to the changed size of the widget 240 and first attributes of one or more first objects 241, 243, 245, 247, 248, and 249 included in the widget 240. The instructions may be configured, when executed by the processor 120, to cause the electronic device 101 to, based on the identified widget template object, relocate the one or more first objects 241, 243, 245, 247, 248, and 249 to the resized widget 250 or 270. The instructions may be configured, when executed by the processor 120, to cause the electronic device 101 to display the resized widget 250 or 270 including the one or more first relocated objects 241, 243, 245, 247, 248, and 249 on the designated screen 265.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

Various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. A singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). If an element (e.g., a first element) is referred to, with or without the term “operatively” or “communicatively”, as “coupled with,” or “connected with” another element (e.g., a second element), it means that the element may be coupled with the other element directly (e.g., through a wire or wires), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a display,
at least one processor, and
memory storing instructions, wherein the instructions, when executed by the at least one processor individually or collectively, to cause the electronic device to:
identify an input to a change in a size of a widget displayed on a screen of the display,
change the size of the widget based on the input,
identify a widget template object corresponding to the changed size of the widget and identify first attributes of one or more first objects included in the widget,
relocate, based on the widget template object, the one or more first objects to a resized widget having the changed size, and
display the resized widget including the one or more first relocated objects on the screen.

2. The electronic device of claim 1, wherein the instructions, when executed by the at least one processor individually or collectively, to further cause the electronic device to, by inputting data regarding the changed size and the first attributes of the one or more first objects into an artificial intelligence (AI) model, identify the widget template object, and
wherein the AI model is trained based on a plurality of widget template objects in which one or more second objects having second attributes are located to output the widget template object indicating location information of the one or more first objects based on the changed size and the first attributes of the one or more first objects.

3. The electronic device of claim 1, wherein the instructions, when executed by the at least one processor individually or collectively, to further cause the electronic device to:
identify similarity between the first attributes of the one or more first objects included in the widget and second attributes of one or more second objects included in each of a plurality of widget template objects, and
identify the widget template object of which the first similarity is greater than or equal to a reference similarity among the plurality of widget template objects.

4. The electronic device of claim 1, wherein the instructions, when executed by the at least one processor individually or collectively, to further cause the electronic device to:
identify, based on the input, whether an asset for the changed size of the widget exists,
based on the asset being identified, relocate the one or more first objects to the resized widget based on the asset, and
based on the asset not being identified, relocate the one or more first objects to the resized widget based on the widget template object.

5. The electronic device of claim 4, wherein the instructions, when executed by the at least one processor individually or collectively, to further cause the electronic device to:
identify, based on the input, another asset with a size closest to the changed size of the widget, and
identify the widget template object corresponding to the changed size of the widget and the first attributes of the one or more first objects included in the another asset.

6. The electronic device of claim 1, wherein the instructions, when executed by the at least one processor individually or collectively, to further cause the electronic device to:
identify the first attributes of the one or more first objects included in the widget,
identify, based on the first attributes, at least one first object among the one or more first objects that is outside a frame of the widget according to the change in the size of the widget,
based on the at least one first object not being identified, adjust a size of the one or more first objects according to the change in the size of the widget without relocating the one or more first objects, and
based on the at least one first object being identified, relocate the one or more first objects to the resized widget.

7. The electronic device of claim 6, wherein the instructions, when executed by the at least one processor individually or collectively, to further cause the electronic device to:
obtain the first attributes at the time when the widget is generated to be displayed on the display, or
obtain the first attributes based on the input.

8. The electronic device of claim 1, wherein the instructions, when executed by the at least one processor individually or collectively, to further cause the electronic device to:
based on the input, identify that the size of the widget is changed,
generate, based on the change in the size of the widget, a new background image by cropping or out-painting a background image of the widget, and
relocate the one or more first objects on the new background image of the resized widget.

9. The electronic device of claim 8, wherein the instructions, when executed by the at least one processor individually or collectively, to further cause the electronic device to:
identify a prompt associated with the changed size, the widget, and the one or more first objects, and
by inputting the prompt into a generative artificial intelligence model, generate the new background image.

10. The electronic device of claim 1, wherein the instructions, when executed by the at least one processor individually or collectively, to further cause the electronic device to:
identify a type of the one or more first objects included in the widget based on data to which a designated type of noise is added to a layout of the widget, and
identify, based on the type of the one or more first objects, the widget template object.

11. A method executed by an electronic device including a display, the method comprising:
identifying an input to a change in a size of a widget displayed on a screen of the display;
changing the size of the widget based on the input;
identifying a widget template object corresponding to the changed size of the widget and first attributes of one or more first objects included in the widget;
relocating, based on the widget template object, the one or more first objects to a resized widget having the changed size; and
displaying the resized widget comprising the one or more first relocated objects on the screen.

12. The method of claim 11, further comprising, by inputting data regarding the changed size, the widget, and the first attributes of the one or more first objects into an artificial intelligence (AI) model, identifying the widget template object,
wherein the AI model is trained based on a plurality of widget template objects in which one or more second objects having second attributes are located to output the widget template object indicating location information of the one or more first objects based on the changed size and the first attributes of the one or more first objects.

13. The method of claim 11, further comprising:
identifying similarity between the first attributes of the one or more first objects included in the widget and second attributes of one or more second objects included in each of a plurality of widget template objects, and
identifying the widget template object of which the similarity is greater than or equal to a reference similarity among the plurality of widget template objects.

14. The method of claim 11, further comprising:
identifying, based on the input, whether an asset for the changed size of the widget exists,
based on the asset being identified, relocating the one or more first objects to the resized widget based on the asset, and
based on the asset not being identified, relocating the one or more first objects to the resized widget based on the widget template object.

15. A non-transitory computer readable storage medium, storing a program including instructions, wherein the instructions, when executed by at least one processor of an electronic device including a display, cause the electronic device to:
identify an input to a change in a size of a widget displayed on a screen of the display,
change the size of the widget based on the input,
identify a widget template object corresponding to the changed size of the widget and first attributes of one or more first objects included in the widget,
relocate, based on the widget template object, the one or more first objects to a resized widget having the changed size, and
display the resized widget including the one or more first relocated objects on the screen.

16. The non-transitory computer readable storage medium of claim 15, wherein the instructions, when executed by the at least one processor, further cause the electronic device to, by inputting data regarding the changed size and the first attributes of the one or more first objects into an artificial intelligence (AI) model, identify the widget template object, and
wherein the AI model is trained based on a plurality of widget template objects in which one or more second objects having second attributes are located to output the widget template object indicating location information of the one or more first objects based on the changed size and the first attributes of the one or more first objects.

17. The non-transitory computer readable storage medium of claim 15, wherein the instructions are configured, when executed by the at least one processor, to further cause the electronic device to:
identify similarity between the first attributes of the one or more first objects included in the widget and second attributes of one or more second objects included in each of a plurality of widget template objects, and
identify the widget template object of which the similarity is greater than or equal to a reference similarity among the plurality of widget template objects.

18. The non-transitory computer readable storage medium of claim 15, wherein the instructions are configured, when executed by the at least one processor, further cause the electronic device to:
identify, based on the input, whether an asset for the changed size of the widget exists,
based on the asset being identified, relocate the one or more first objects to the resized widget based on the identified asset, and
based on the asset not being identified, relocate the one or more first objects to the resized widget based on the identified widget template object.

19. The non-transitory computer readable storage medium of claim 18, wherein the instructions are configured, when executed by the at least one processor, further cause the electronic device to:
identify, based on the input, another asset with a size closest to the changed size of the widget, and
identify the widget template object corresponding to the changed size of the widget and the first attributes of the one or more first objects included in the another asset.

20. The non-transitory computer readable storage medium of claim 15, wherein the instructions are configured, when executed by the at least one processor, further cause the electronic device to:
identify the first attributes of the one or more first objects included in the widget,
identify, based on the first attributes, at least one first object among the one or more first objects that is outside a frame of the widget according to a change in the size of the widget,
based on the at least one first object not being identified, adjust a size of the one or more first objects according to the change in the size of the widget without relocating the one or more first objects, and
based on the at least one first object being identified, relocate the one or more first objects to the resized widget.
